(19) United States
(12) Patent Application Publication
(10) Pub. No.: US 2018/0009628 A1
(43) Pub. Date: Jan. 11, 2018

(54) REEL MADE OF MOLDED COMPONENTS

(71) Applicant: Sonoco Development, Inc., Hartsville, SC (US)

(72) Inventor: Harvey Charles Echols, JR., Bastrop, LA (US)

(73) Assignee: Sonoco Development, Inc., Hartsville, SC (US)

(21) Appl. No.: 15/639,146

(22) Filed: Jun. 30, 2017

Related U.S. Application Data
(60) Provisional application No. 62/358,936, filed on Jul. 6, 2016.

(51) Int. Cl. B65H 75/14; B29C 43/14; B65H 75/50; B29K 311/14; B29K 105/26; B29K 105/12; B29K 103/00; B29L 31/00

(52) U.S. Cl. CPC B65H 75/14; B65H 75/50; B29C 43/14; B29L 2031/704; B29K 2105/26; B29K 2105/12; B29K 2103/00; B65H 2701/5122; B65H 2701/5126; B29K 2311/14

(57) ABSTRACT

A composition for making a molded article such as a reel flange, and a method making the same, are provided. The composition may consist essentially of about 75-95 wt % dry waste wood and about 10-25 wt % binder such as melamine-urea-formaldehyde (MUF) or PMUF resin. The waste wood may be recycled wood fiber from pine or other hardwoods, sawdust and wood chips. The method comprises mixing dry waste wood with MUF or PMUF resin binder to make a wood/resin mixture, and compressing the wood/resin mixture in a mold cavity at a pressure and temperature.

### BACKGROUND

### Field of the Invention

This patent relates to an article molded from a mixture of waste wood and binder. More particularly, this patent relates to reel components and a method of making reel components by hot compression molding a mixture of waste wood and a resin binder.

### Description of the Related Art

A number of references disclose methods of making articles from waste material and a resin binder. For example, Weyerhaeuser U.S. Pat. No. 2,583,618 discloses a process for hot compression molding articles from a mixture of wood sawdust and resin. A bottom platen is wetted with water prior to molding. Heat is provided by heating the platens. Patton U.S. Pat. No. 2,719,328 discloses a process for hot compression molding articles from a mixture of wood sawdust and resin. Munk U.S. Pat. No. 3,261,897 discloses a tool and process for hot compression molding articles from a mixture of shredded organic matter and resin.

Pringle U.S. Pat. No. 3,956,541 discloses a reel made of 40-70% wood filler, 30-60% scrap thermoplastic and a resin binder. Jacobsen U.S. Pat. No. 6,164,588 discloses a reel made by cold molding a mixture of wood and thermoplastic.

Wooden reels commonly are used to hold wire and cable. The wooden reels serving the marketplace today typically are made of solid wood produced from virgin timber. A common quality complaint with the current wood reels (constructed out of virgin timbers) is breakage; splintering; cracking; etc. Wood reels also utilize a significant number of nails that can become exposed and puncture the wire or cable product.

The present disclosure addresses these needs and concerns by providing a molded reel having improved strength performance(s), smoother surfaces and no nails.

### SUMMARY OF THE INVENTION

The present disclosure relates to a composition for making a molded article such as a reel flange, and a method making the same.

In one aspect, a composition is provided comprising or consisting essentially of about 75-90 wt % dry waste wood (waste wood dried to a moisture content of about 3 to 6%) and about 10-25 wt % binder, wherein the binder is a melamine-urea-formaldehyde (MUF) resin or a PMUF resin. The waste wood may be recycled wood fiber from pine or other hardwoods, sawdust and wood chips.

In another aspect, a molded reel flange is provided. The reel flange may comprise a first inner facing surface, a second, outer facing surface spaced axially apart from the inner facing surface, a groove configured to fixedly engage a drum, and a rim radially distant the hub. The reel flange may be made of a mixture of 75-90 wt % dry waste wood and 10-25 wt % resin binder. The flange body may vary in thickness or density.

In another aspect, a method of making a molded wooden article is provided. The method may comprise the following steps:

(a) Drying waste wood and/or wood fiber;

(b) Mixing about 75-90 wt % dry waste wood with about 10-25 wt % MUF resin or PMUF resin binder to make a wood/resin mixture;

(c) Compressing the wood/resin mixture at a pressure while heating the mixture to form a formed product having a desired size and shape.

The molded product may be coated with a moisture barrier compound.

### THE DRAWINGS

FIG. 1 is a perspective view of a reel made of molded components according to the disclosure.

FIG. 2 is an exploded perspective view of the reel of FIG. 1 comprising a drum and two flanges.

FIG. 3 is a cross sectional view of one of the flanges of FIG. 2 taken along line 3-3.

FIGS. 4 to 8 are views of a male flange.

FIG. 4 is an outer perspective view of a male flange.

FIG. 5 is an outer side view of the male flange of FIG. 4.

FIG. 6 is an inner perspective view of the male flange of FIG. 4.

FIG. 7 is an end view of the male flange of FIG. 4.

FIG. 8 is a cross-sectional view of the male flange of FIG. 5 taken along line 8-8.

FIGS. 9 to 13 are views of a female flange.

FIG. 9 is an outer perspective view of a female flange.

FIG. 10 is an outer side view of the female flange of FIG. 9.

FIG. 11 is an inner perspective view of the female flange of FIG. 9.

FIG. 12 is an end view of the female flange of FIG. 9.

FIG. 13 is a cross-sectional view of the female flange of FIG. 10 taken along line 13-13.

FIG. 14 is a perspective view of a reel in accordance with an exemplary embodiment of the present disclosure.

FIG. 15 is a side view of two stacked reels.

FIG. 16 is a flowchart illustrating a method of making a molded article according to the disclosure.

### DETAILED DESCRIPTION OF THE INVENTION

The present disclosure relates to a molded article and a method of making the molded article. It should be understood that, although the description that follows addresses molded reel components such as reel flanges and how to make them, other articles besides reel flanges can be made according to the teachings of this disclosure.

While the invention described herein may be embodied in many forms, there is shown in the drawings and will herein be described in detail one or more embodiments with the understanding that this disclosure is to be considered an exemplification of the principles of the invention and is not intended to limit the invention to the illustrated embodiments.

### Conventional Wood Reels

Reels of the type used to carry heavy wire, cable or the like are commonly made of wood produced from virgin timber. But wood reels are subject to breakage; splintering and cracking. Wood reels also utilize a significant number of nails that can become exposed and puncture the wire or cable.

To address these problems, the present disclosure relates to a molded reel having improved strength performance, smoother surfaces and no nails, and a method of making molded reel components, particularly but not exclusively reel flanges

### Reel Comprising Molded Components

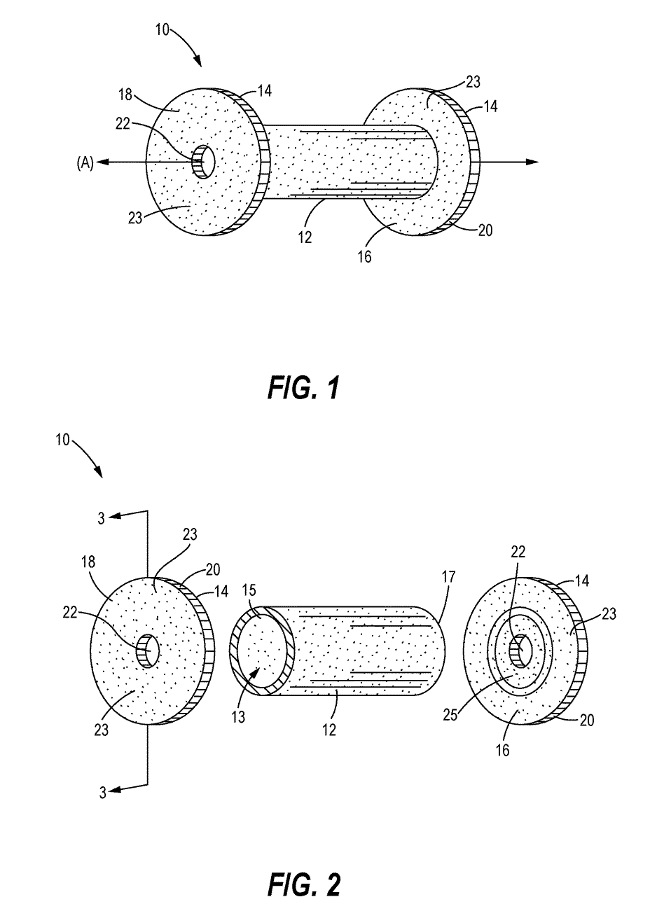

FIG. 1 is a perspective view of a reel 10 having molded components. The reel 10 comprises a drum 12 and two flanges 14. As explained in more detail below, any of all of the reel components may be made of molded waste wood. The drum 12 is cylindrical and defines an axis (A) about which the drum 12 can rotate.

FIG. 2 is an exploded perspective view of the reel 10 of FIG. 1. The drum 12 may be hollow, with a central bore 13 that extends axially from one drum end 15 to an opposite drum end 17. During assembly of the reel 10, each drum end 15, 17 may be captured within a groove 25 in a corresponding flange 14. The flanges 14 may be further secured to the drum 12 by bolts, tie-rods, adhesives or other fastening means (not shown).

Each flange 14 may comprise a flange body 23 having a first, inner or drum facing, surface 16 and a second, outer facing surface 18 spaced axially apart from the inner facing surface 16. As noted above, each flange body 23 may define an annular groove 25 on its drum facing surface 16 to receive an end 15, 17 of the drum 12. Each flange body 23 may define a central opening 22. Each flange 14 may comprise a rim or outer perimeter 20 radially distant the central opening 22. The flanges 14 may have any suitable diameter, with 40 to 50 inches being typical.

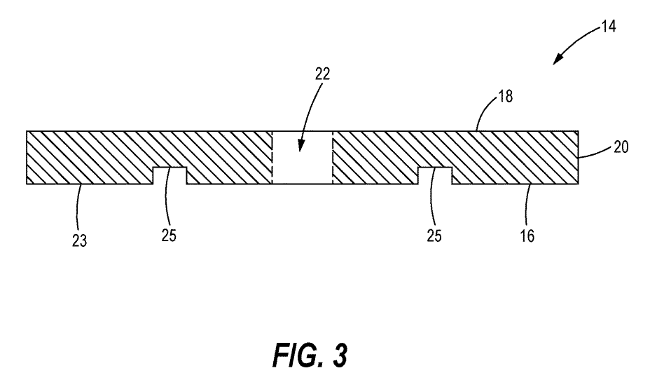

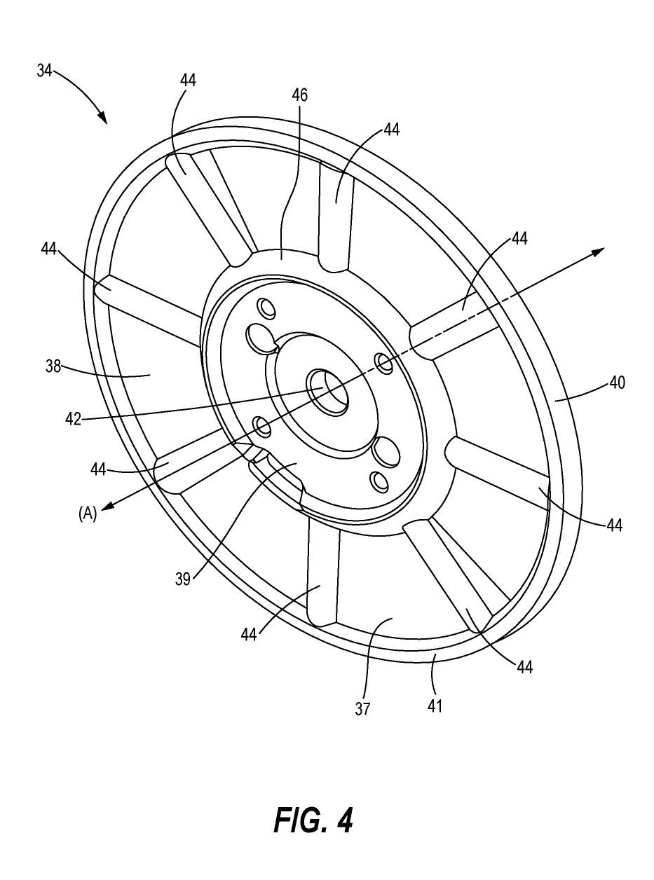

FIG. 3 is a cross sectional view of one of the flanges 14 of FIG. 2 taken along line 3-3. The drum receiving groove 25 extends only partway through the flange body 23.

The flange 14 may be molded to any suitable configuration (shape), including one that varies in thickness or density to save material while maintaining sufficient strength and durability.

### Other Flange Configurations

Of course, the drum 12 and flange 14 illustrated in FIGS. 1 and 2 are just two examples of the many articles that can be molded according to this disclosure. For example and without limitation, a flange can be molded according to this disclosure having spindles (ribs) that extend radially outward from about the center to about the rim. Also, flanges can be molded that may be secured or otherwise affixed to each other along their outer-facing surfaces. Two such flanges will now be described.

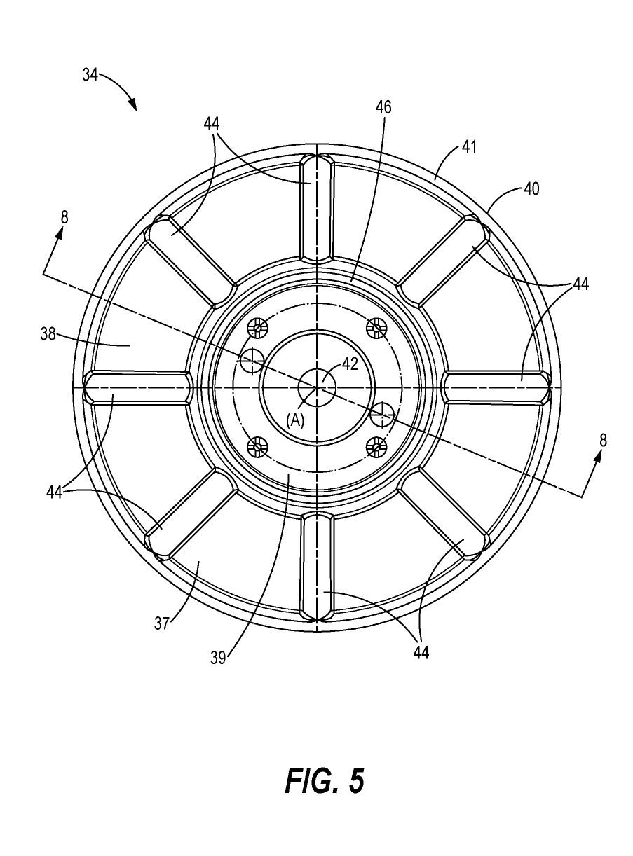

FIG. 4 is an outer perspective view and FIG. 5 is an outer side view of a flange 34, herein after referred to as a male flange 34. The male flange 34 comprises a substantially disk-shaped body 37 and a rim 40.

The body 37 has an inner surface 36 (which faces the drum in an assembled reel) and an outer surface 38 spaced axially apart from the inner surface 36. The body 37 may define a central opening 42. The body 37 may have an axis (A) about which it can rotate that corresponds with the axis (A) in the assembled reel.

The rim 40 extends axially away from the body 37 in the outward direction—away from the drum in the assembled reel—and terminates in a substantially circular edge 41. The circular edge 41 defines a outer plane (OP) (FIG. 8) that is orthogonal to the axis (A).

The outer surface 38 of the body 37 may comprise a central hub 39, a (preferably circular) boss 46 located between the hub 39 and the rim 40, and spindles or ribs 44 extending radially between the boss 46 and the rim 40. The boss 46 may be centered around the axis (A) and extends axially outward from the outer surface 38 of the flange body 37. The spindles 44 may be concave when viewed from the outer surface 38 as in FIGS. 4 and 5. The spindles 44 provide strength to the male flange 34.

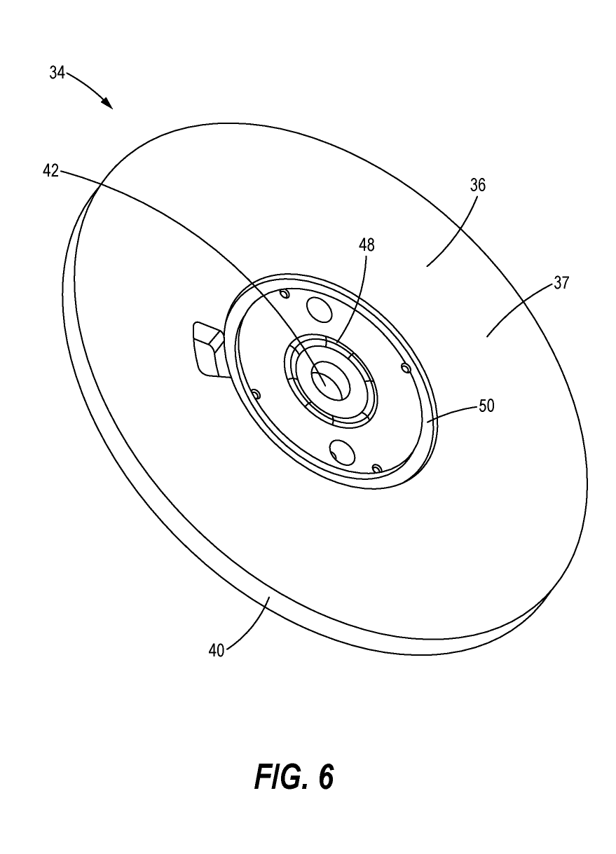

FIG. 6 is an inner perspective view of the male flange 34 of FIG. 4. From this view it is clear that the inner surface 36 is substantially planar and mainly comprises the body 37. The body 37 extends preferably continuously from the central opening 42 to the rim 40 and defines a inner plane (IP) (FIG. 8) that is orthogonal to the flange axis (A). The planar body 37 may define a (preferably circular) annular groove 50 located between the central opening 42 and the rim 40 and configured to receive an end 15, 17 of a drum 12. An annular ring 48 may extend inwardly (in the direction of the drum 12 if one were present, but away from the flange 34) and may be located between the central opening 42 and the groove 50.

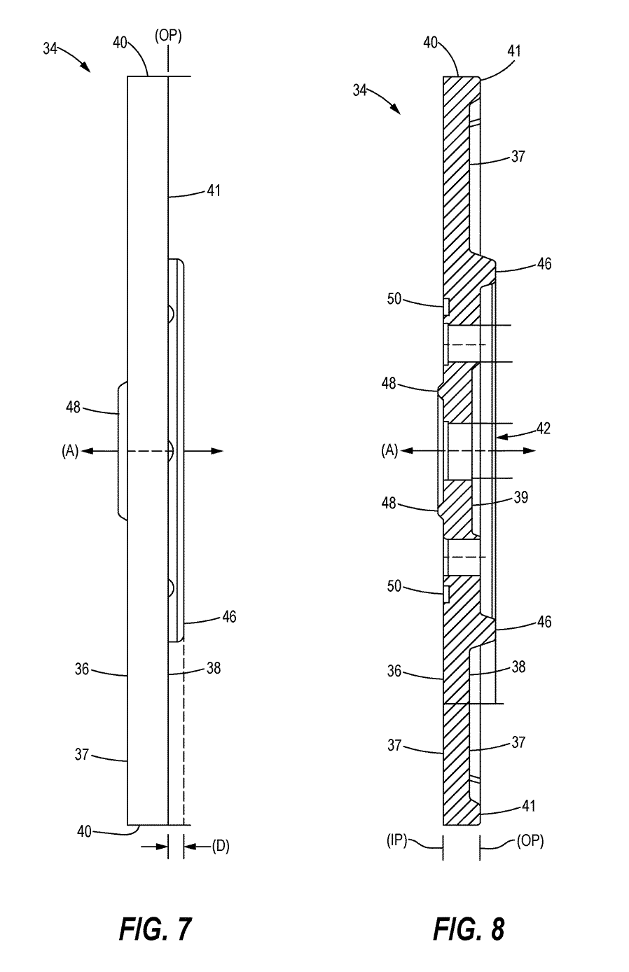

FIG. 7 is an end or rim view of the male flange 34 of FIG. 4. The inner surface 36 is to the left and the outer surface 38 is to the right. The boss 46 can be seen extending axially outward a distance (D) beyond the outer plane (OP) defined by the rim edge 41—the reason why is explained below. The annular ring 48 can be seen extending axially inward from the flange inner surface 36.

FIG. 8 is a cross-sectional view of the male flange 34 of FIG. 5 taken along line 8-8. The flange body 37 may be tapered in the outwardly radial direction. That is, the body 37 may decrease in axial thickness as it approaches the rim 40. The planar body 37 may have a first thickness near the boss 46 and a second, relatively smaller thickness near the rim 40.

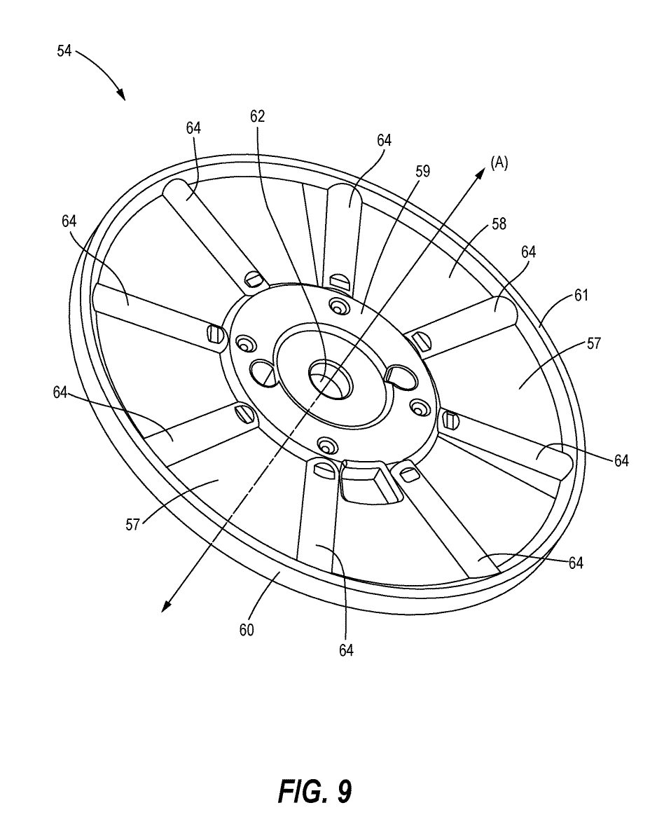

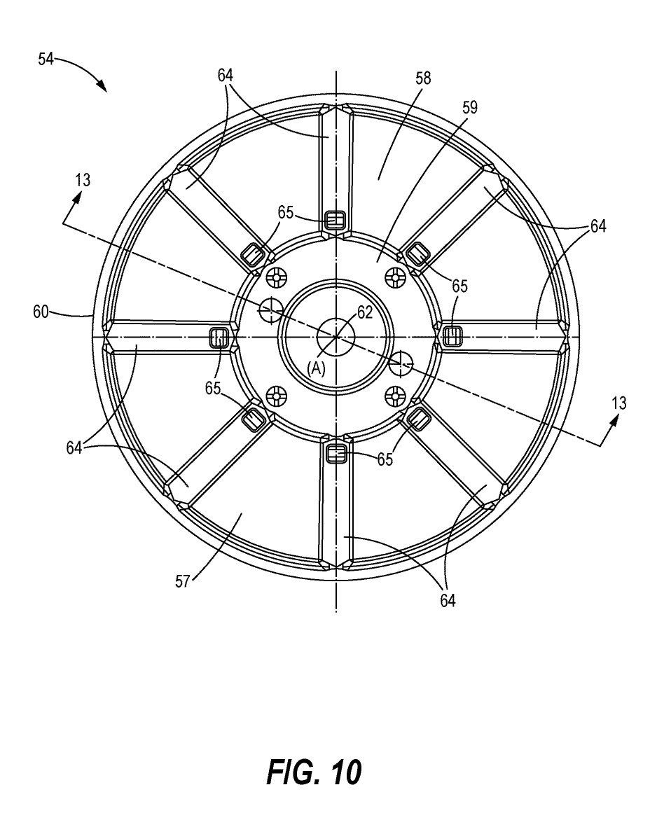

FIG. 9 is an outer perspective view and FIG. 10 is an outer side view of another flange, hereinafter referred to as a female flange 54. The female flange 54 comprises a body 57 and a rim 60.

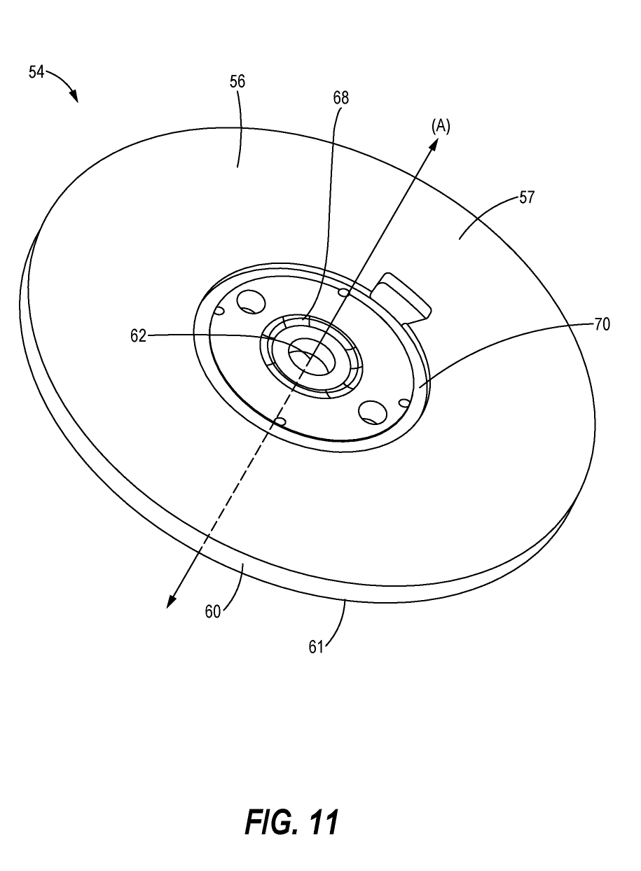

The body 57 has an inner, or drum facing, surface 56 and an outer surface 58 (obscured in FIGS. 9 and 10 but shown in FIG. 11) spaced axially apart from the inner surface 56. The body 57 may define a central opening 62. Like the previously described male flange 34, the flange body 57 is shaped substantially like a disk which can rotate about an axis (A).

The rim 60 is substantially annular and extends axially away from the body 57 in the outward direction and terminates in a substantially circular edge 61. The circular edge 61 defines a outer plane (OP) (FIG. 13) that is orthogonal to the axis (A).

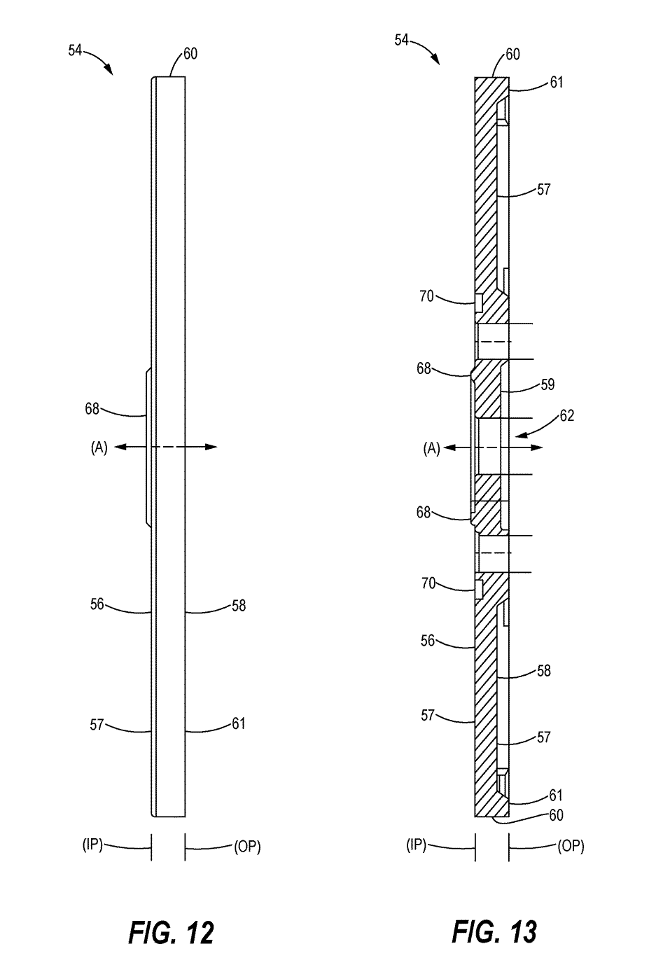

The outer surface 58 of the body 57 may comprise a central hub 59 and spindles or ribs 64 extending radially outward between the central hub 59 and the rim 60. Each spindle 64 defines a notch 65 for receiving a portion of the male flange boss 46. The notches 65 may be equidistant from the axis (A) and may be located in a circular array about the axis (A). The notches 65 may form a circle having a radius equal to the radius of the boss 46. As is apparent in FIGS. 12 and 13, the central hub 59 preferably does not extend beyond the outer plane (OP) defined by the edge 61 of the rim 60.

FIG. 11 is an inner perspective view of the female flange 54 of FIG. 9. From this view it is clear that the inner surface 56 is planar and comprises the flange body 57. The body 57 extends from the central opening 62 to the rim 60 and defines a plane that is orthogonal to the flange axis (A). The body 57 may define a (preferably circular) annular groove 70 located between the central opening 62 and the rim 60 and configured to receive an end 15, 17 of a drum 12. An annular ring 68 may extend inwardly (in the direction of the drum if one was present, but away from the flange 54) and may be located between the central opening 62 and the groove 70. As noted above, the annular ring 68 has a slightly different (outer/inner) diameter so that it can engage the annular ring 48 on the male flange 34 to register the flanges 34, 54 during shipping and handling.

FIG. 12 is an end or rim view of the female flange 54 of FIG. 9. The inner surface 56 is to the left and the outer surface 58 is to the right. The annular ring 68 can be seen extending axially inward from the inner surface 56. Since the central hub 59 does not extend beyond the outer plane (OP) defined by the axially outer edge 61 of the rim 60, it is not visible in this view.

FIG. 13 is a cross-sectional view of the female flange 54 of FIG. 10 taken along line 13-13. Like the planar body 37 of the male flange 34, the planar body 57 may be tapered in the outwardly radial direction. That is, the planar body 57 may decrease in axial thickness as it approaches the rim 60.

### Palletless Design

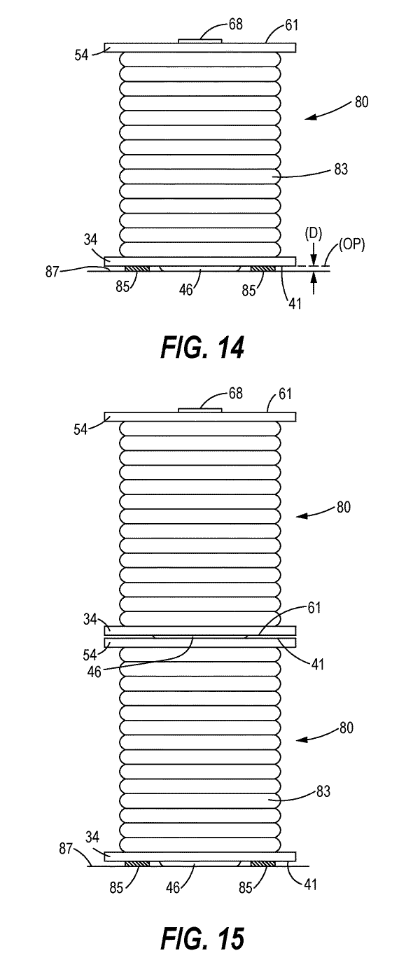

FIG. 14 is a perspective view of a reel 80 in accordance with an exemplary embodiment of the present disclosure. The reel 80 comprises a drum (obscured in FIG. 14), a male flange 34 and a female flange 54. The reel 80 rests male flange down on a surface 87. A cable 83 is wound around the drum.

The male flange 34 is designed to eliminate the need for a pallet. That is, when the reel 80 is placed on a surface 87 with the male flange 34 down, the male flange 34 provides enough clearance above the surface 87 to allow forklift forks 85 to enter under male flange 34 for handling. Referring to FIGS. 7 and 14, the boss 46 extends beyond the outer plane (OP) of the rim 40 a distance (D) that is of a sufficient magnitude to create a gap between the male flange 34 and the surface 87 upon which the reel 80 is resting so that the forks 85 can be inserted under the male flange 34 to lift the reel 80. The boss 46 should have a diameter which allows the forks 85 to be positioned interior to the rim 40 of the male flange 34.

### Reel Stackability

The male flange 34 and the female flange 54 are designed to enhance reel stackability for improved shipping and handling. FIG. 15 is a side view of two stacked reels 80. Each reel 80 comprises a male flange 34 at the bottom and a female flange 54 at the top. The male flange 34 of the top reel 80 registers with the female flange 54 of the bottom reel 80 to provide stackability and stability. Specifically, the boss 46 of the male flange 34 fits within the notches 65 of the female flange 54 to hold the two reels 80 in a stable vertical alignment. The vertical dimensions of the boss 46 and the notches 65 may be such that the respective rim edges 41, 61 are spaced apart, typically about ⅜ inches. Flange Stackability A male flange 34 and a female flange 54 may be positioned closely together to minimize the space required during shipping and handling. This space savings may be accomplished by positioning the male and female flanges 34, 54 with their outer surfaces facing each other so that the notches 65 of the female flange 54 receive the boss 46 of the male flange 34.

Alternatively, the male and female flanges 34, 54 may be positioned with their inner surfaces facing each other. The annular ring 48 of the male flange 34 functions like a stacking boss by engaging a slightly larger (or smaller) diameter annular ring 68 on the female flange 54 to register the two flanges 34, 54 for better handling and shipping.

### Flange Composition

The composition of the flanges 34, 54 may comprise or consist essentially of wood waste and a binder. More specifically, the flange composition may comprise about 75-90 wt % (dry) wood waste and about 10-25% binder. The composition does not include any thermoplastic.

The wood waste may be any suitable wood product or mixture of wood products, such as recycled wood or wood fiber from pine or other hardwoods possibly sourced from the wood chip market, sawdust and wood chips. Preferably the waste wood is dried to a moisture content of about 3 to 6%.

The binder may be any suitable binder, and preferably is melamine-urea-formaldehyde (MUF) resin or a PMUF resin (an MUF resin with a small proportion of phenol).

### Waterproofing

In one possible variation the flange or other molded article is coated so that the article is waterproof. Any suitable waterproofing coating may be used. For example and without limitation, after conducting water soak tests with various compounds, it has been found that the following coatings may be useful for waterproofing purposes:

1. Flex Seal™ liquid rubber flexible coating available commercially from Swift IP, LLC of Weston, Fla.

2. Barrier Pro 4545™ general purpose latex available commercially from Mallard Creek Polymers of Charlotte, N.C.

3. Wax or wax compositions. Waterproofing an article with wax may be accomplished by submerging the molded article in molten wax for a period of time, such as thirty minutes.

### Method of Making a Molded Flange

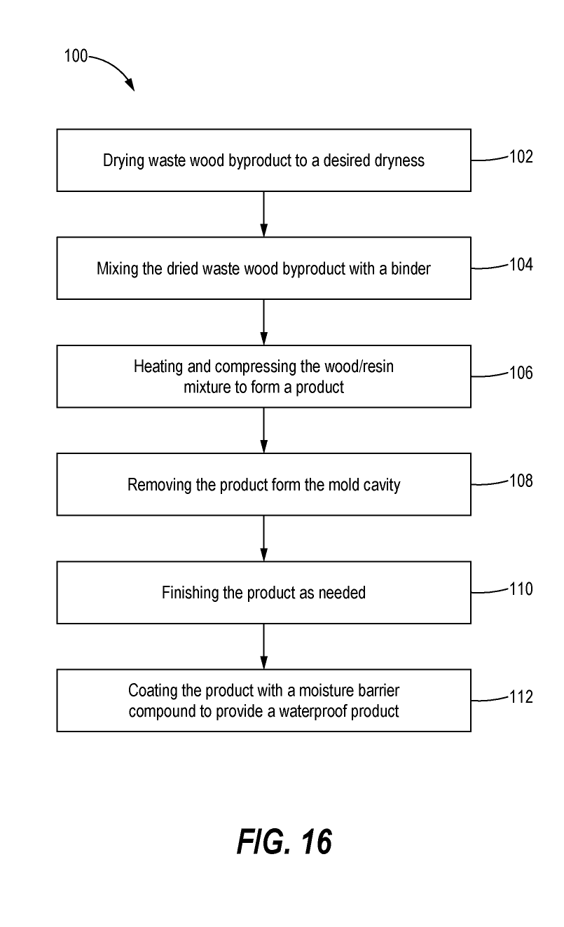

FIG. 16 is a flowchart illustrating a method of making a molded article such as a flange or other reel component. The method may be referred to as “hot compression molding” because the mold is heated and/or steam is injected into the mold during the compression step.

The method 100 may comprise the following steps:

Step 102: Drying waste wood byproduct to a desired dryness. A mixture of recycled wood fiber from pine or other hardwoods may be sized and reduced through a Hammer mill screen, then dried to a pre-determined moisture content, preferably between 3 and 6% or 4.5 and 5%.

Step 104: Mixing about 75 to 90% dried waste wood byproduct with about 10 to 25% binder. Preferably the binder is melamine-urea-formaldehyde (MUF) resin or a PMUF resin. As noted above, each flange body 23 may define an annular groove 25 on its drum facing surface 16 to receive an end 15, 17 of the drum 12.

Step 106: Compressing the wood/resin mixture in a mold cavity under heated conditions to form a product having the desired geometry (size and shape). Preferably the compression step is done at a pressure of at least 500 psi and perhaps substantially higher.

Heating the mold/mixture activates the binder to form the product. The mold temperature may be about 250 to about 350 F. The mold/platens may be heated to provide the heat of binder activation. Alternatively or additionally, steam may be injected into the mixture prior to compression to speed the core heating.

The cycle time, i.e., time that the wood/resin product resides in the mold can vary, and may be between 4 to 6 minutes, depending on the density of the various parts of the product being formed, the moisture content of the wood/resin, and the heating method used.

Step 108: Removing the formed product from the mold cavity.

Step 110: Sanding, deburring or otherwise finishing the formed product as needed. For example, flashing created by the mold seams may be sanded off during this step.

Step 112: Optionally, coating the formed product with a moisture barrier compound and allowing the coated product to dry to provide a waterproof product.

In a variation on the method described above, prior to the compression step 106 the wood/resin mixture may be pre-pressed to create a preform. This step may comprise cold pressing a weighted charge with a cold press ram to create the preform. Then the preform is transferred to the mold cavity for the compression step.

### INDUSTRIAL APPLICABILITY

Thus there has been described a molded wooden reel for use in the wire and cable reel markets and other markets. The reel is constructed is such a manner to meet or exceed all current common specifications of the solid wood reels that dominate the market today.

The molded waste wood reel components are sustainable (since the components are reusable and made from recycled wood) and may exhibit superior strength characteristics—molded wood flanges may be up to 2 to 3 times stronger pound-for-pound compared to two-ply wood flanges. Molded waste wood reel components may also have smooth surfaces and an absence of nails and splinters typically found in conventional wood reels. Also, molded waste wood products of the kind described herein can offset the current virgin timber consumption with waste products from other wood working operations.

In addition to those described herein, examples of reel components that could be manufactured according to this disclosure can be found in co-owned U.S. Pat. Nos. 6,164,588; 8,567,037 and 9,278,827, the disclosures of which are incorporated herein by reference.

Other articles that could be molded according to the disclosure include those disclosed in co-owned U.S. Pat. No. 3,499,397 (pallet) and U.S. Pat. No. 8,317,150 (shipping base).

It is understood that the embodiments of the invention described above are only particular examples which serve to illustrate the principles of the invention. Modifications and alternative embodiments of the invention are contemplated which do not depart from the scope of the invention as defined by the foregoing teachings and appended claims. It is intended that the claims cover all such modifications and alternative embodiments that fall within their scope.

1. A composition for making a molded product, the composition comprising:
about 75-90 wt % dry waste wood; and
about 10-25 wt % binder, wherein the binder is a melamine-urea-formaldehyde (MUF) resin or a PMUF resin.

2. The composition of claim 1 wherein the waste wood is selected from the group consisting of recycled wood fiber from pine or other hardwoods, sawdust and wood chips.

3. The composition of claim 1 wherein the composition does not include a thermoplastic.

4. The composition of claim 1 wherein the composition consists essentially of:
about 75-95 wt % dry waste wood; and
about 10-25 wt % binder, wherein the binder is a melamine-urea-formaldehyde (MUF) resin or a PMUF resin.

5. The composition of claim 1 wherein the molded product is a reel flange.

6. A reel comprising:
a cylindrical drum defining an axis (A) and having a first end and an opposing second end;
a male flange affixed to the first end and comprising a body and a rim, the body having an inner surface and an outer surface spaced axially apart from the inner surface, the rim extending axially outward away from the body and terminating in a substantially circular edge, the outer surface comprising a substantially circular boss extending axially outward from the outer surface a distance (D) beyond the edge of the rim, the inner surface being substantially planar and defining an annular groove configured to receive an end of the drum; and
a female flange affixed to the second end and comprising a body and a rim, the body having an inner surface and an outer surface spaced axially apart from the inner surface, the rim extending axially outward away from the body and terminating in a substantially circular edge, the outer surface comprising spindles circumferentially disposed around the outer surface, each spindle defining a notch, the inner surface being substantially planar and defining an annular groove configured to receive an end of the drum; wherein
when the reel is positioned, male flange down, on top of a second, similarly constituted reel also positioned male flange down, the boss of the reel fits within the notches of the second reel.

7. The reel of claim 6 wherein:
when the reel is stacked on top of the second reel, the rim edge of the reel abuts the rim edge of the second reel.

8. The reel of claim 6 wherein:
the body is tapered in the outwardly radial direction.

9. The reel of claim 6 wherein:
the body decreases in axial thickness in the radially outward direction.

10. The reel of claim 6 wherein:
the male flange and the female flange are coated with a waterproof compound.

11. The reel of claim 10 wherein:
the waterproof compound comprises wax.

12. A method of making a molded product comprising the steps of:
drying waste wood and/or wood fiber;
mixing about 75-90 wt % dry waste wood with about 10-25 wt % MUF or PMUF resin binder to make a wood/resin mixture; and
compressing the wood/resin mixture in a mold cavity at a pressure and temperature to form a product having a desired size and shape.

13. The method of claim 12 further comprising the step of:
finishing the formed product.

14. The method of claim 12 further comprising the step of:
coating the formed product with a moisture barrier compound.

15. The method of claim 14 wherein:
the moisture barrier compound comprises wax.

16. The method of claim 12 wherein the molded product is a reel flange.

17. The method of claim 16 wherein:
the reel flange is a male reel flange comprising a body and a rim, the body having an inner surface and an outer surface spaced axially apart from the inner surface, the rim extending axially outward away from the body and terminating in a substantially circular edge, the outer surface comprising a substantially circular boss extending axially outward from the outer surface a distance (D) beyond the edge of the rim, the inner surface being substantially planar and defining an annular groove configured to receive an end of a drum.

18. The method of claim 16 wherein:
the reel flange is a female flange comprising a body and a rim, the body having an inner surface and an outer surface spaced axially apart from the inner surface, the rim extending axially outward away from the body and terminating in a substantially circular edge, the outer surface comprising spindles circumferentially disposed around the outer surface, each spindle defining a notch, the inner surface being substantially planar and defining an annular groove configured to receive an end of a drum.

19. The method of claim 16 wherein:
during the drying step the waste wood is dried to a moisture content of between about 3% and about 6%.

20. The method of claim 12 wherein:
after the mixing step and before the compressing step, pre-pressing the wood/resin mixture to create a preform; and
during the compressing step, instead of compressing the mixture, compressing the preform.
